(19) United States
(12) Patent Application Publication
(10) Pub. No.: US 2010/0182338 A1
(43) Pub. Date: Jul. 22, 2010

(54) DIFFRACTIVE TECHNOLOGY BASED METHOD AND SYSTEM FOR DYNAMIC CONTRAST MANIPULATION IN DISPLAY SYSTEMS

(75) Inventors: Gunnar Hedin, Tyreso (SE); Richard Berglind, Alvsjo (SE); Tore Svortdal, Horten (NO); Benny Svardal, Horten (NO)

Correspondence Address: KNOBBE MARTENS OLSON & BEAR LLP, 2040 MAIN STREET, FOURTEENTH FLOOR, IRVINE, CA, 92614, US

(73) Assignee: POLIGHT AS, Horten (NO)

(21) Appl. No.: 12/331,352

(22) Filed: Dec. 9, 2008

Related U.S. Application Data
(63) Continuation of application No. 12/106,992, filed on Apr. 21, 2008, now abandoned.
Application No. 12/106,992 is a continuation of application No. PCT/NO2006/000360, filed on Oct. 16, 2006.

(30) Foreign Application Priority Data
Oct. 19, 2005 (NO) 20054829

(51) Int. Cl. G09G 5/00; G02B 26/00

(52) U.S. Cl. 345/617; 359/238

(57) ABSTRACT

A method and system providing dynamic contrast control in scanning line color display systems, and particularly a method and system comprising at least two modulator units is disclosed. One modulator unit is for modulating pixel information in a line to be displayed while the other one provides illumination intensity control over different pixel areas or clusters of pixels of said same line to be displayed by using a tunable diffractive grating element (TDG) in the illumination path to provide image source dependent active brightness level control, i.e. ‘dynamic contrast’, as well as a shutter function for pixels off transition periods.

### RELATED APPLICATIONS

This application is a continuation of U.S. application Ser. No. 12/106,992, titled “Diffractive Technology Based Method and System for Dynamic Contrast Manipulation in Display Systems,” filed Apr. 21, 2008, which is a continuation of PCT/NO2006/000360, filed Oct. 16, 2006, which was published in English and designated the U.S., and claims priority to NO 20054829 filed Oct. 19, 2005, each of which are incorporated herein by reference.

### BACKGROUND OF THE INVENTION

1. Field

The field is related to a method and system for providing dynamic contrast in scanning line color display systems, and particularly to a method and system comprising at least two modulator units, one for modulating pixel information in a line to be displayed while the other one provides illumination intensity control over different pixel areas or clusters of pixels of said same image line to be displayed.

2. Description of the Related Technology

Color Display Systems must provide high contrast and gray scale resolution. Poor contrast makes image details indistinguishable from each other below a certain gray scale level. Poor gray scale resolution also results in missing image details, as well as artifacts like e.g., contouring. In addition, poor gray scale resolution limits the accuracy of color reproduction, especially at low brightness levels.

The minimum black level brightness, and hence maximum contrast, for an individual pixel in the image is governed by a combination of display dynamic range, system contrast, and cross-talk effects.

The dynamic range of the display is often the limiting factor for the image contrast.

A limited dynamic range is especially a problem for non-emissive displays, using a light modulator and an illumination source with a constant brightness level. In this case the light modulator must both adjust the brightness level of an individual pixel relative to the brightness of the other pixels in the image, as well as adapt the overall image scene brightness to the correct level.

The gray scale resolution of the display is limited amongst others by the drive electronics resolution and the response speed of the modulator. Especially for digital, pulse width modulated displays, the requirement to adapt the overall scene brightness to the correct level, results in a reduced dynamic range left over for regulating the gray scales of individual pixels relative to each other in the image.

Display systems using light modulators and a constant level illumination source typically yields lower contrast ratio, brighter dark levels, and less gray scale resolution, as compared to emissive state-of-the-art systems based on e.g., CRT technology. This reduces the image quality and competitiveness of such display technologies.

Prior art has several proposed solutions for solving these tasks in display systems. However, for example direct lamp modulation has currently a limited potential due to small available adjustment range and negative effects on light output stability and lamp lifetime. For use with laser illumination, direct laser source modulation seems not possible with current technology, due to stability issues.

Using variable mechanical apertures in illumination or projection path imply a cost/reliability issue, uniformity problems, and offer only a limited adjustment step resolution. For laser based displays variable mechanical apertures in the light path would mean a more complex optical system, and give edge diffraction effects which reduce the quality of the illumination beam.

WO 2005/022925 discloses a method and system for dynamic contrast control for a display system (100) for displaying a picture according to an input signal (158, 160, 162). The display system (100) can be divided in picture processing part (104) and an optical display system (102). The picture processing system (104) comprises mainly a control unit (154). The optical display system (102) comprises a light source (106) for generating a light beam, collecting optics (110, 112) for collecting and focusing the light beam, light modulator (148a, 148b, 148c) for modulating information from input signal (158, 160, 162) on the light beam. The control unit (154) controls the light incident on the light modulators (148a, 148b, 148c) according to light information and contrast in the input signals (158, 160, 162). However, the teaching of this invention describes how shutter and diagram solutions, and direct power control of light source can be used, however, for much slower time intervals that is necessary for achieving dynamic contrast in a line scan based system.

U.S. Pat. No. 5,724,456 A discloses a method for adjusting the light effect in a picture (201) based on digital picture analysis. A computer (18) receives picture information in a picture (201) that comprises both intensity information and cromoto graphic information, and transfer computed picture information to a storage unit (226), a monitor (20), printer (14) or a remote display (26). The picture information is transferred from a recorder (200) to an input buffer (202) that transfers the picture information to a picture computing circuitry (205). The picture computing circuitry (205) divides the picture information in several picture elements in a dividing circuit (204) with a size of one×1 to m×n (picture sizes), preferably 8×8. The picture elements are grouped in sectors in a sector circuitry (206). The mean light power for the picture elements in each sector is decided in an element circuitry (208). Thresholds for the different sectors are identified, and the information is computed resulting in an adjustment of picture information that is transferred to the storage unit.

RU 2080 C41 discloses a TV projector that in an example of embodiment comprises three light sources (13) that via collimator lenses (14) transfer light towards three prisms (17) mounted on a relief modulator (1). The relief modulator (1) comprises a plurality of grounded line electrodes (8) and a transparent electrode layer (3), wherein a reference voltage is applied between these.

In a combination of these three disclosures are none trivial. RU 2080641 C is using pulsed light, and therefore there is no reference about how to control the light source. There is no teaching in any of these publications about how to achieve such a control. For example, combining 2,080 C41 C with dynamic contrast, and achieve a good result, it is necessary to design optics with accompanying modulator technology that is not trivial. Therefore, it is still a problem in prior art to find a solution for achieving dynamic contrast in a line scan based system. For example, none of these three publications describe how it is possible to achieve correct optical quality and speed.

### SUMMARY OF CERTAIN INVENTIVE ASPECTS

It is one aspect that by using a tunable diffraction creating technology (TDG), it is possible to divide a picture in very small sectors that can provide a gliding intensity transition. Earlier established solution has common that it is a discrete transition between sectors that provides a negative visual result. Further, it is also an aspect of the present invention that e linear array and time synchronization can provide a two-dimensional sector division in the projected picture.

According to another, a novel method and a system provides dynamic adjustment of light source intensity in a laser based projection display system, which compared to prior art solutions has benefits in form of individual illumination intensity control over different pixel areas in the displayed image, low cost and system complexity, high optical efficiency, increased adjustment step resolution and absence of optical artifacts inherent with mechanical aperture solutions in combination with laser illumination.

The method and system for dynamic illumination control allows the display to make use of a greater portion of the display's dynamic range, which leads to increased maximum bit-depth, increased color resolution and improved black levels in images.

According to another aspect, dynamic control could also be operated as an optical shutter in a line scan projection system, synchronized with the display electronics and scan mirror, to minimize the illumination intensity during pixel-to-pixel transition time and mirror fly-back or polygon drum transition time, and hence reduce black level and increase image contrast in images.

According to an example, a system for modulating the intensity of the illumination in a laser projection system comprise transmitting the illuminating light through a tunable diffractive grating (TDG).

Adjusting the drive voltage will vary the distribution of light output intensity between 0 and higher diffraction orders.

According to one embodiment, a TDG unit based on light diffraction due to surface modulation in a thin gel layer or a membrane (elastomer) with equal optical and functional characteristics is used. An example of such a modulator is illustrated in FIG. 2. The modulator comprise a thin layer of gel (or elastomer) 11, adjacent to a transparent modulator prism 12. The gel membrane is index matched to the prism glass, and the gel has low light absorption (less than 2% in a typical system). Typically, the gel layer is 15-30 μm thick. Electrodes, 13, are processed on a flat substrate layer separated from the gel surface by a thin air gap (5-10 μm thick). The spacing can be arranged differently as known to a person skilled in the art. An ITO (indium tin oxide) layer, 14, is used to apply a bias voltage across the gel and the air gap. As a result, a net force acts on the gel surface due to the electric field. In addition it is possible to individually address each signal electrode. By applying a local signal voltage, forces are applied to the gel surface, resulting in a surface modulation. Several electrodes can be grouped together such that the applied signal voltage on those electrodes results in a local surface modulation of the gel, thus enabling the control of individual modulator pixels, for example.

According to one embodiment, a display system comprises at least two different TDG units. One TDG unit is arranged with electrodes providing pixel modulation of a line to be displayed. In one embodiment, the pixel TDG unit has one row of pixels where the number of pixels equal the resolution of the displayed line, hi another example of embodiment, the pixel row may comprise two adjacent parallel arrays of pixels. The other one of said TDG units provide a picture element modulation by having electrodes grouped in sections that equal the number of picture elements that may be manipulated according to contrast considerations. According to an example of embodiment, the number of picture elements is one hundred. In another embodiment, the number of picture elements is 3.

According to one aspect, by controlling applied voltages on the electrodes of the pixel modulating TDG unit and the contrast controlling TDG unit, control of brightness level and color content of image frames, brightness and color distribution within frames, and brightness and color changes between consequent image frames for moving images may be achieved.

According to one embodiment, an image signal processing unit (ISP) synchronizes and controls the light modulation of the at least two TDG components. According to one embodiment, the ISP calculates an intensity level to be used for each frame, and controls the TDG component to yield corresponding illumination intensity.

According to an aspect, the intensity level to be used is related to a relative measure between the actual intensity level of a selected area of a frame and necessary intensity level to achieve the correct contrast level of said frame. For example, a bright shining sun in an image may have an actual brightness far below the possible brightness of the display system. By identifying the difference between this actual intensity and the maximum possible intensity, the system has identified a scaling factor that may be used to scale all picture elements relative to this increased intensity level without imposing errors in the relative intensity between the picture elements, in another example, a shadow from a tree may be too dark to reveal details of objects displayed in the shadow. By measuring the difference between intensity in the shadow area with an intensity level providing details of objects, the system has identified a correct scaling of the intensity for the whole image.

For example, a dark image frame where the maximum frame intensity level is calculated to be 50% compared to the maximum brightness output of the display system, the ISP controls the contrast TDG unit to adjust the illumination intensity to 50%. The brightness level of the pixel data fed to the display modulator is increased correspondingly.

If the original source signal defined a pixel brightness level of 50%, the ISP will control the display modulator to display the same pixel with 100% brightness level, as 50% system brightness already has been achieved by the contrast TDG unit. Similarly, an original pixel brightness of 20% will be modulated to 40% brightness level by the display modulator.

An example of display system using a TDG unit, further comprise a blocking filter, 15, designed to transmit the 0th order diffracted light output from the TDG dynamic chip (TDG DC), while light in higher orders are absorbed or reflected. The transmitted light is imaged via relay optics onto the display modulator, which in turn is imaged via projection optics to be viewed, e.g. on a screen.

According to one aspect, said screen is not only a canvas type of screen. The screen may also be the retina in a human eye, and the present invention may also be used in a retina display system. Other screen types may be of any type or material providing imaging possibilities.

Compared to conventional solutions for achieving dynamic illumination level control, the method and system according to the present invention provides major benefits in form of individually addressable and adjustable illumination intensity of different parts (picture elements) of a displayed image, a smaller form factor, solid state device with no external moving parts, improved durability, ease of thermal management, improved response speed and dynamic range of the system, as well as a lower cost of production, hi addition, the present invention enables intensity control of a laser beam without introducing edge diffraction effects as seen with mechanical aperture solutions.

### BRIEF DESCRIPTION OF THE DRAWINGS

FIG. 1 illustrates an example of illumination intensity control.

FIG. 2 illustrates the working principle of a TDG unit.

FIG. 3 depicts an example of an embodiment.

FIG. 4 depicts an example of an embodiment.

FIG. 5 depicts an example of an embodiment.

FIGS. 6a and 6b illustrate the relation between image information and illumination intensity for pixel cluster dynamic illumination intensity control.

FIGS. 7a and 7b illustrate the relation between image information and illumination intensity for pixel line dynamic illumination intensity control.

FIGS. 8a and 8b illustrate the relation between image information and illumination intensity for full frame dynamic illumination intensity control.

FIGS. 9a and 9b illustrate the effect of dynamically controlled illumination intensity on display dynamic range and image grays ale resolution.

FIG. 10 depicts a system flow diagram with dynamically controlled illumination intensity for an embodiment.

### DETAILED DESCRIPTION OF CERTAIN INVENTIVE EMBODIMENTS

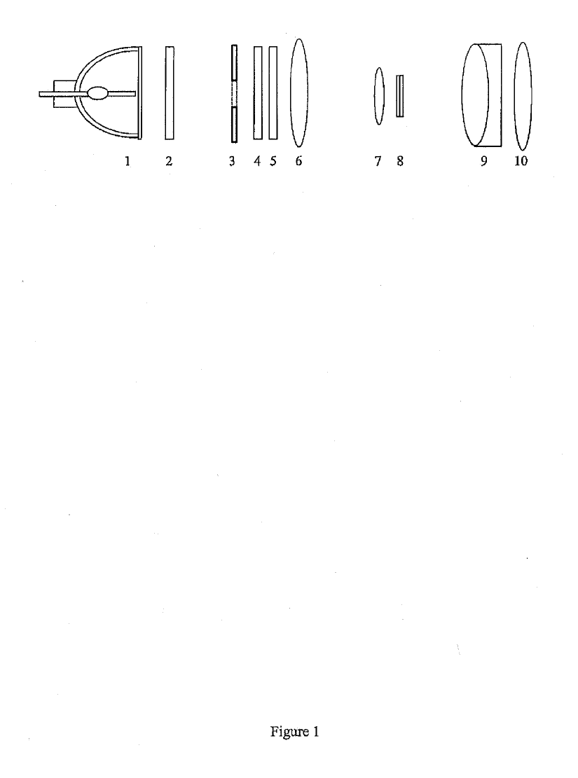

FIG. 1 illustrates a system using an adjustable mechanical aperture device. The light source 1 transmits light through a lens array 2 which is in optical contact with a mechanical adjustable aperture 3. After the aperture 3, the light passes a polarization recovery element 5 before the light is projected onto a LCD (Liquid Crystal Display) device providing the modulation of the image before the image is projected onto a screen (not shown) via projection optics 9.

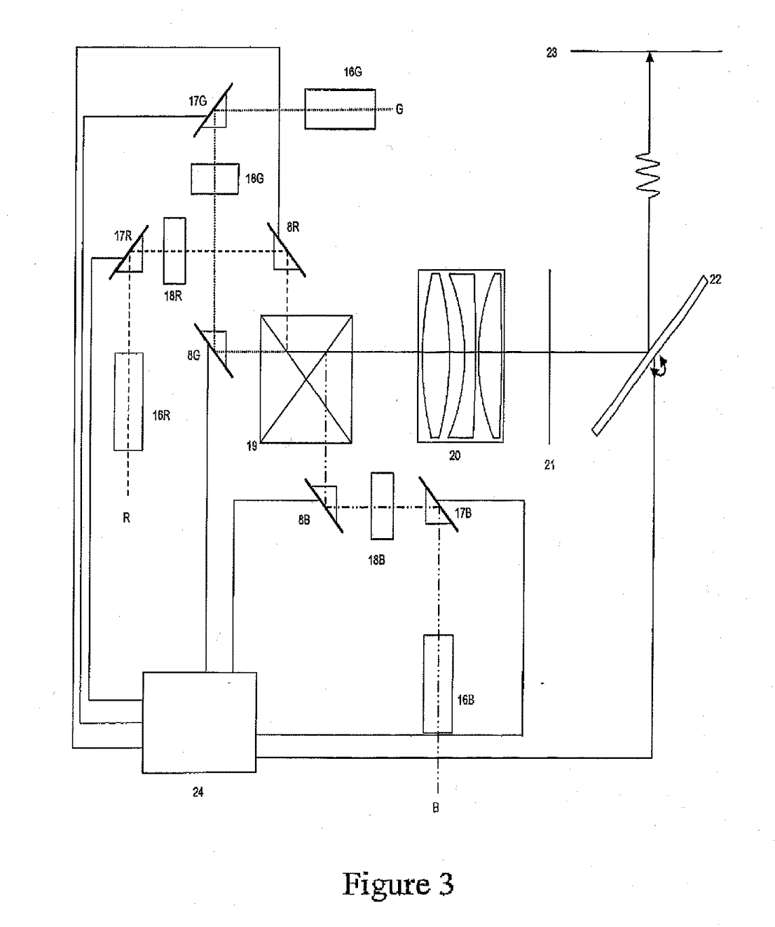

FIG. 3 illustrates an embodiment of a display system used for pixel cluster control comprising a laser source divided into three light sources of Red, Green and Blue laser light, as known to a person skilled in the art. Three sets of image line generating optics, 16R, 16G, 16B, are used to generate three image lines to be displayed of three different colors. Each image line to be displayed is incident on a tunable diffractive grating dynamic chip (TDG) contrast controller, 17R, 17G, and 17B, which separately modulate different parts (picture elements or cluster of pixels) of the image line to be displayed. Each modulated image line to be displayed is mapped onto the corresponding display modulator, 8R, 8G, and 8B providing pixel related grey scale control of the image line to be displayed using individual optical relay systems, 18R, 18G, 18B. The relay optics also serves as filters for blocking the light diffracted from the TDG contrast controllers. Each picture element on the TDG contrast controller 17R, 17G, 17B can be mapped onto one or several (a cluster) pixels on the display modulator 8R, 8G, 8B, respectively depending on the desired resolution for the dynamic contrast.

The modulated laser beams are coaxially aligned into a single path with e.g., an X-prism, 19, which is followed by a projection system comprising projection optics, 20, a schlieren stop, 21, and a rotating mirror, 22, that project the modulated combined single path line across a screen surface, 23, to generate a color 2D-image.

An image signal processing unit (ISP), 24, controls the light modulation of TDG contrast controllers in the illumination path and display modulators. The ISP also synchronizes the signals communicated to the modulators with the control signal communicated to the scanning mirror, which generates the 2D-image.

For full brightness throughput, the TDG contrast controller 17R, 17G, 17B introduce minimum diffraction on the incoming beam, allowing most of the energy to be transmitted in the 0th order. When a picture frame consists of mainly lower brightness level data, and an illumination level reduction is desired, the diffractive component shifts more energy towards higher diffraction orders. The optical relay system, 18R, 18G, 18B, which contains an aperture which blocks these higher orders, limits the illumination level onto the display modulator, 8R5 8G, 8B thus generating highly improved contrast levels in the image, as well as an increased dynamic range (bit-depth) for the display.

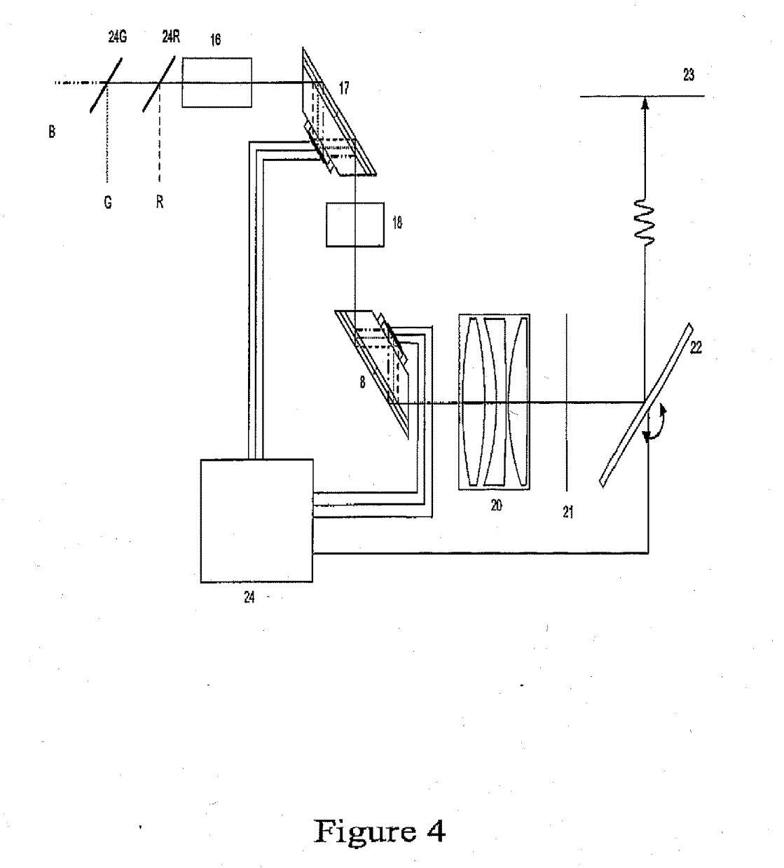

FIG. 4 illustrates an embodiment comprising a single chip, multi-channel color solution used for pixel cluster control. The different laser colors, R, G, and B (red, green, and blue) are coaxially aligned with the aid of two dichroic filters (other components, e.g., an X-prism can also be used to perform this alignment), 24R and 24G and directed through line generating optics (common to all colors), 16, to the TDG contrast controller, 17, which modulates the different beams individually in three modulator sections. The modulated beams are mapped onto a corresponding single-chip, multi-channel display modulator, 8, by an optical relay system, 18, which also blocks out the light diffracted by the TDG contrast controller and directed towards the projection optics, 20. A schlieren stop, 21, is used to filter out unwanted diffraction orders and a projection (scanning) mirror, 22, is used to generate a 2D-image onto the screen, 23. An image signal processing unit (ISP), 24, controls the light modulation of both the TDG contrast controller and the display modulator. The ISP also synchronizes the signals communicated to these modulators with the control signal communicated to the scanning mirror, which generates the 2D-image.

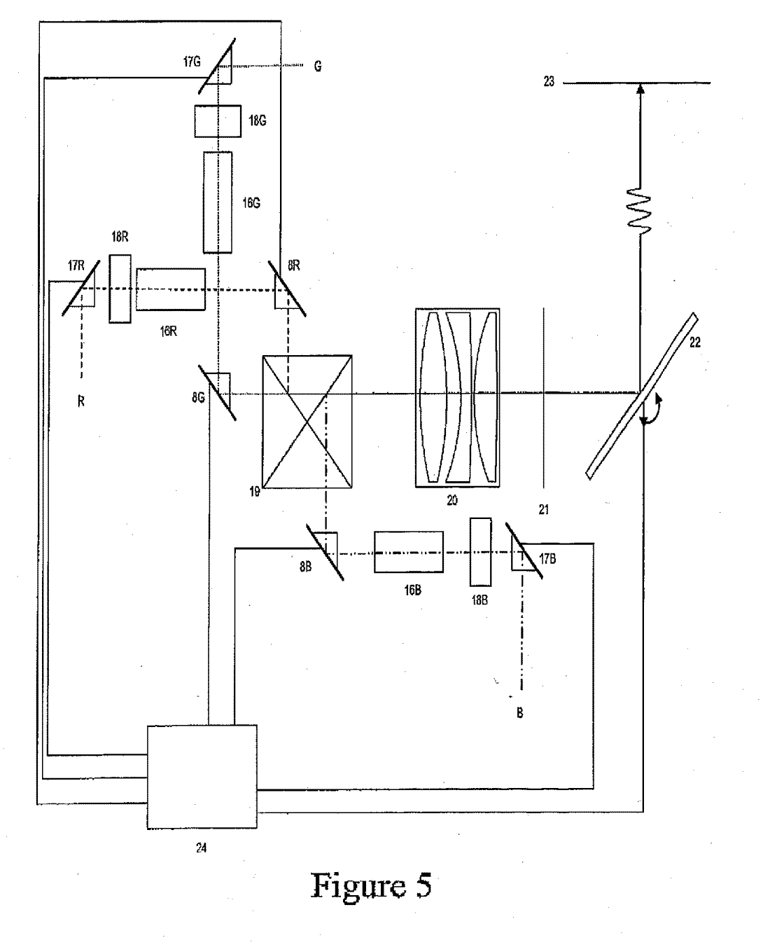

FIG. 5 illustrates an embodiment used for pixel line control. Three different laser colors, R, G5 and B (red, green, and blue), are directed to a corresponding TDG contrast controller, 17R, 17G, and 17B. Individual optical relay systems, 18R, 18G, and 18B are used to filter out the diffracted light and direct the remaining light towards line generating optics, 16R, 16G, and 16B. Each modulated laser line is incident on a corresponding display modulator, 8R, 8G, and 8B. The modulated beams are coaxially aligned into a single path with e.g., an X-prism, 19, which is followed by a projection system comprising projection optics, 20, a schlieren stop, 21, and a rotating mirror, 22, that projects (scan) the modulated image lines to be displayed across a screen surface, 23, to generate a 2D-image.

An image signal processing unit (ISP), 24, controls the light modulation of both TDG contrast controllers and display modulators. The ISP also synchronizes the signals communicated to these modulators with the control signal communicated to the scanning (projection) mirror, which generates the 2D-image.

The TDG contrast controller is used to reduce the illumination level evenly across the display modulator. Therefore, this setup in FIG. 5 controls the dynamic contrast on a pixel line basis. When generating an image the illumination intensity generated by the TDG contrast controller can be used for one or several consecutive pixel image lines to be displayed depending on the desired resolution for the dynamic contrast.

According to another embodiment, dynamic control is operated as an optical shutter in said embodiment, synchronized with the display electronics and scan mirror, to minimize the illumination intensity during pixel-to-pixel transition time and mirror fly-back or polygon drum transition time, and hence reduce black level and increase image contrast in images.

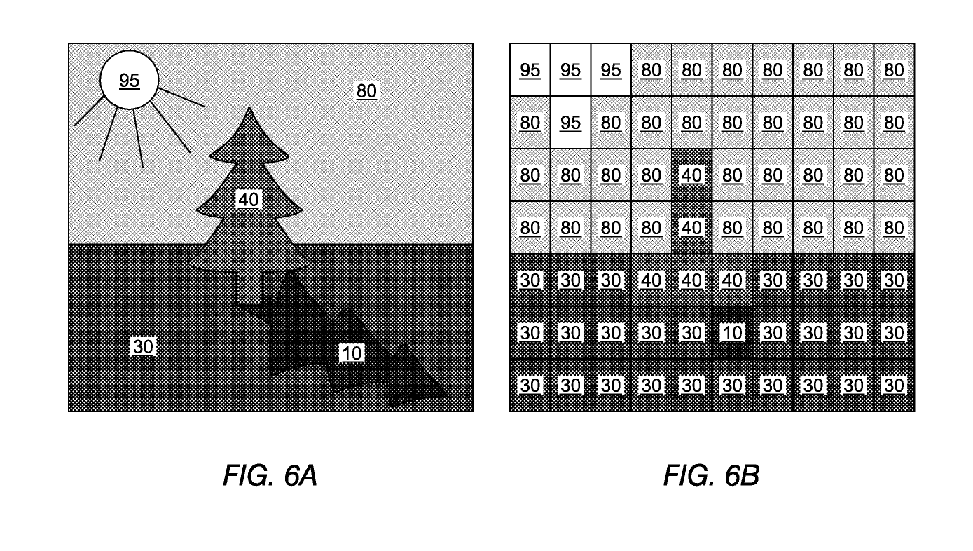

FIG. 6 depicts the relation between image information and illumination intensity for pixel cluster dynamic illumination intensity control. A simple image is shown on the left side, a. The image has, for simplicity, been divided into several areas wherein the maximum relative intensity within said area is displayed. A relative value of 0 corresponds to black and a relative value of 100 corresponds to white. The right hand side of the figure, b, depicts the illumination intensity within different clusters of pixels generated by the TDG contrast controller.

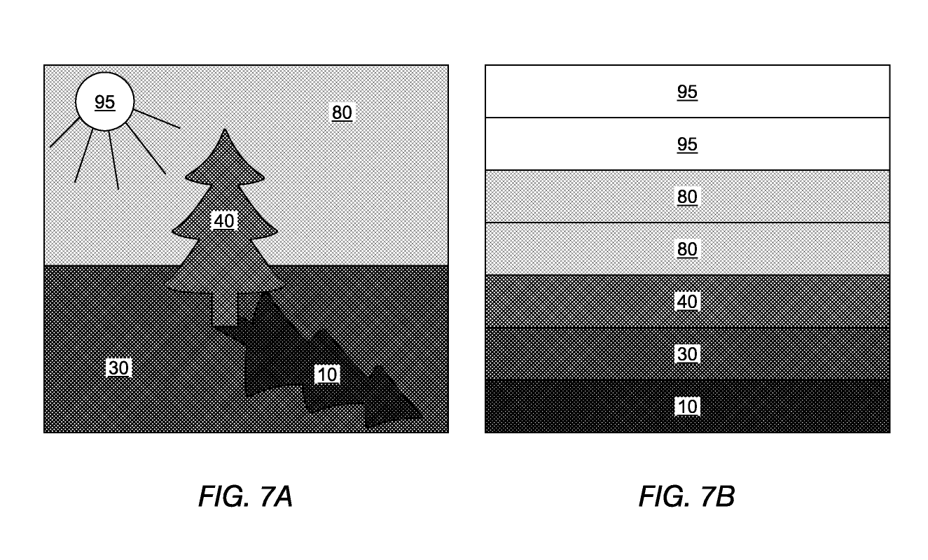

FIG. 7 shows the relation between image information and illumination intensity for pixel line dynamic illumination intensity control. A simple image is shown on the left side, a. The image has, for simplicity, been divided into several areas wherein the maximum relative intensity within said area is displayed. A relative value of 0 corresponds to black and a relative value of 100 corresponds to white. The right hand side of the figure, b, shows the illumination intensity within different pixel lines generated by the TDG contrast controller.

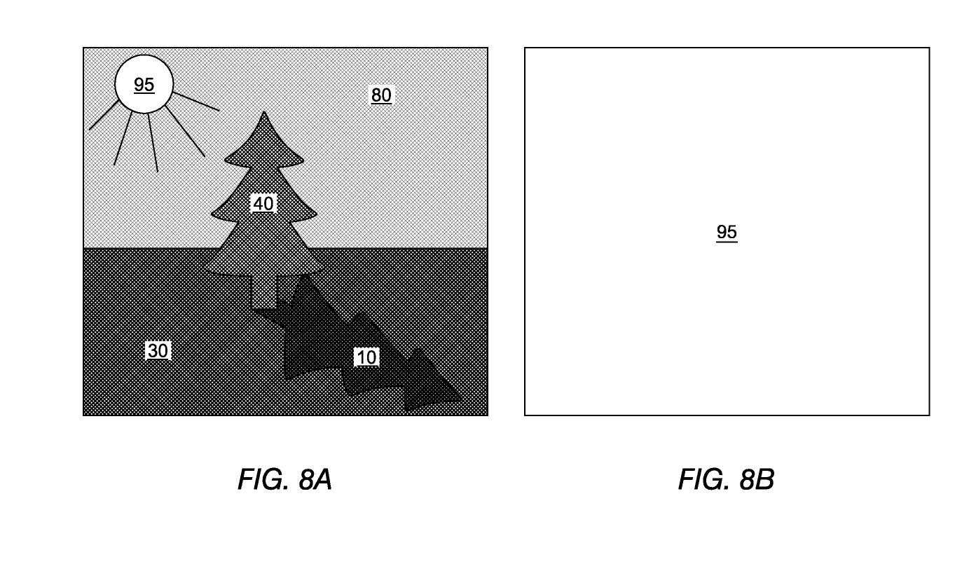

FIG. 8 illustrates the relation between image information and illumination intensity for full frame dynamic illumination intensity control. A simple image is shown on the left side, a. The image has, for simplicity, been divided into several areas wherein the maximum relative intensity within said area is displayed. A relative value of 0 corresponds to black and a relative value of 100 corresponds to white. The right hand side of the figure, b, shows the illumination intensity within different pixel lines generated by the TDG contrast controller.

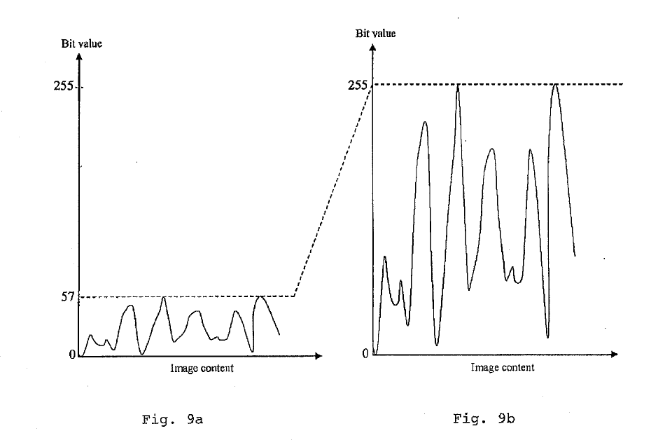

FIG. 9 is an illustration of the effect achieved by the present invention of dynamically controlled illumination intensity on display dynamic range and image grayscale resolution. The left hand part, a, of FIG. 9 depicts an image content as bit values for a conventional system with one modulator. The bit value ranges from 0 to 57 corresponding to a fairly dark image where only a part of the modulator's dynamic range is used. If a TDG contrast controller according to a method according the present invention is introduced in the illumination path and the relative illumination level of said component is set to 57/255=22%, the full dynamic range of the display modulator can be used. The resulting image content of the display modulator after scaling is seen in the right hand side of FIG. 9, b, with a resulting increase in contrast.

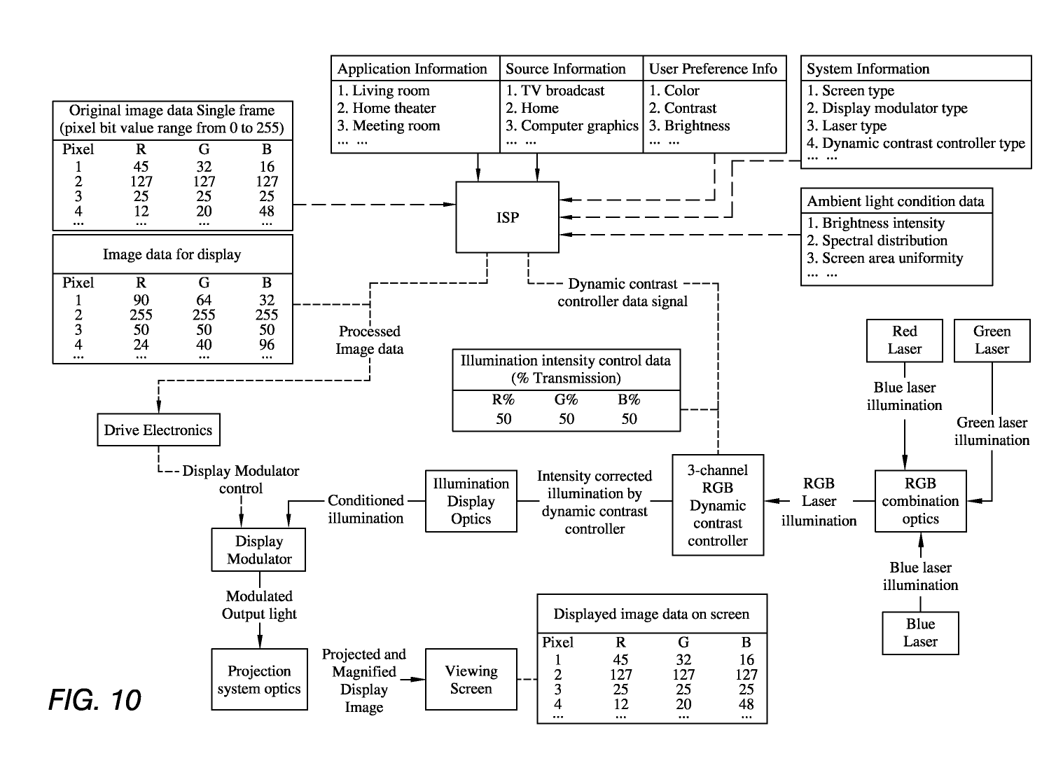

FIG. 10 illustrates a display system. Typically, several parameters contribute to the adjustment of correct brightness and contrast in a display system as illustrated in FIG. 10. Some parameters are user adjusted, for example color intensity. Other parameters are acquired through user experience. For example, if the display system is to be used in a living room, home theater etc., this is communicated by the user to the ISP controller as depicted in FIG. 10. Other parameters that may influence the performance of the system can for example be the screen type.

In FIG. 10 such parameter selections are illustrated as input to the ISP controller. A data set for R, G and B values corresponding to an example of image frame is also depicted. The resulting scaling of values is illustrated in the output frame communicated to the display modulator. The resulting manipulation of values of the displayed frame is also illustrated as the R, G and B values projected on the screen.

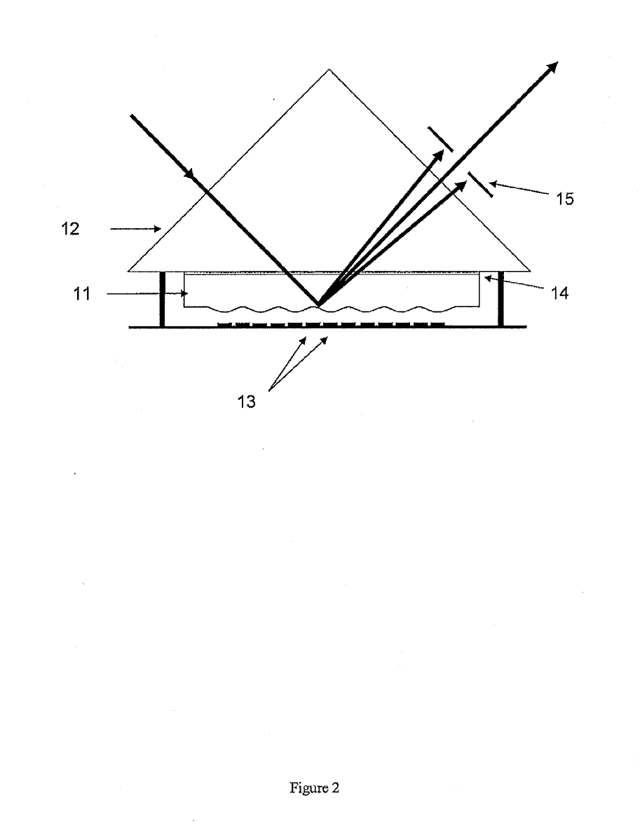

The actual identification of necessary scaling value in a frame is based on the actual division of picture elements as defined by the number of picture elements the TDG contrast controller can handle, and the actual algorithm performing the analysis of frames running in an ISP controller, such as the ISP controller depicted in FIG. 10. The number of picture elements the TDG contrast controller can handle is defined by for example the grouping of electrodes in a gel based TDG modulator as depicted in FIG. 2. If the grouping of electrodes provide three picture elements, the frames displayed in a system as depicted in FIG. 10 using such a three grouped TDG component, may be divided into three sections which the analyzing software may execute in for example the ISP processor that will identify the relative scaling factor. For example, the software may search the sections to identify the brightest pixel displayed in each section. For example, the mean value of all three brightest pixels may be used to identify the difference between the mean value and the maximum possible brightness for the frame which will provide a scaling as depicted for example in FIG. 9. In another embodiment, the section in a frame to be used for identifying the scaling may be user identifiable. For example, the system may provide a cursor type of interaction between the user and the displayed images which allow the user to draw for example a contour identifying the section to be used for the identification of the scaling factor. If the number of picture elements possible to handle in the corresponding TDG contrast controllers, for example one hundred, any contour may be identified with enough resolution to yield the correct scaling of the system up or down.

The application of the system on pixel cluster control as depicted in FIG. 6, pixel line control as depicted in FIG. 7, or full frame control as depicted in FIG. 8 is governed primarily by the application software running in the ISP controller. Implementation of such algorithms in an ISP controller is known to a person skilled in the art. In an embodiment, several different algorithms are embedded in the ISP controller. Selection of a particular algorithm may be user selectable.

While the above detailed description has shown, described, and pointed out novel aspects as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others.

What is claimed is:

1. A method of providing dynamic contrast control in a scanning line display system, the system comprising tunable diffraction grating (TDG) modulator technology, wherein the method comprises:
partitioning a frame to be displayed in a number of picture elements,
in each picture element, identifying a reference pixel with a first brightness value,
calculating a difference between said first brightness value and a second brightness value related to imaging quality in said display system,
based on said calculated difference value, evaluating at least one scaling factor to be used to manipulate picture element contrast and grey scale resolution of pixels for said picture frame,
using said at least one scaling factor to control modulation of said picture elements in a first light modulator divided in a number of sections that equal said number of picture elements, and
wherein said modulated light output from said first light modulator is in optical contact with a second light modulator divided in a number of sections that equal a number of pixels used in said display system.

2. The method according to claim 1, wherein said partitioning of said frame and evaluation of said at least one scaling factor is for dynamic pixel cluster illumination intensity control.

3. The method according to claim 1, wherein said partitioning of said frame and evaluation of said at least one scaling factor is for dynamic pixel line illumination intensity control.

4. The method according to claim 1, wherein said partitioning of said frame and evaluation of said at least one scaling factor is for dynamic full frame illumination intensity control.

5. The method according to claim 1, wherein said modulation of light in said first modulator comprises controlling said modulator as a shutter blocking illumination errors related to movements of a projection mirror in said display system.

6. The method according to claim 1, wherein said first brightness value is related to said reference pixel having maximum brightness level in said picture element.

7. The method according to claim 1, wherein said first brightness value is related to said reference pixel having minimum brightness level in said picture element.

8. The method according to claim 1, wherein said imaging quality is related to maximum intensity level of displayed images in said display system.

9. The method according to claim 1, wherein said imaging quality is related to minimum intensity level of displayed images in said display system.

10. The method according to claim 1, wherein said first brightness level and said second brightness level is user selectable.

11. A scanning line projection display system comprising:
a tunable diffraction grating technology modulator;
a light source;
an image signal processor (ISP) unit;
a rotating projection mirror in optical contact with projection optics; and
at least one first light modulator configured to receive incident light from said light source, wherein said at least first modulator is partitioned into individual modulating sections corresponding to individual picture elements of an image line to be displayed in said display system, and wherein modulated light form said at least one first modulator is in optical contact with at least one second light modulator partitioned into a number of pixels used in said display system.

12. The scanning line projection display system according to claim 11, wherein said ISP unit executes a program for performing a dynamic illumination intensity control according to a method comprising:
partitioning a frame to be displayed in a number of picture elements,
in each picture element, identifying a reference pixel with a first brightness value,
calculating a difference between said first brightness value and a second brightness value related to imaging quality in said display system,
based on said calculated difference value, evaluating at least one scaling factor to be used to manipulate picture element contrast and grey scale resolution of pixels for said picture frame,
using said at least one scaling factor to control modulation of said picture elements in a first light modulator divided in a number of sections that equal said number of picture elements, and
wherein said modulated light output from said first light modulator is in optical contact with a second light modulator divided in a number of sections that equal a number of pixels used in said display system.

13. The scanning line projection display system according to claim 11, wherein said at least one first light modulator and said at least one second light modulator each comprise a tunable diffraction grating (TDG) modulator.

14. The scanning line projection display system according to claim 11, wherein said light source is a laser light source comprising three light sources, one for red light, one for green light and one for blue light.

15. The scanning line projection display system according to claim 14, wherein said first light modulator comprises three modulators, one for red light, one for green light and one for blue light.

16. The scanning line projection display system according to claim 14, wherein said second light modulator comprises three modulators, one for red light, one for green light and one for blue light.

17. The scanning line projection display system according to claim 14, wherein said first light modulator comprises one modulator partitioned into three separate modulators, one for red light, one for green light and one for blue light.

18. The scanning line projection display system according to claim 14, wherein said second light modulator comprises one modulator partitioned into three separate modulators, one for red light, one for green light and one for blue light.
